(19) United States
(12) Patent Application Publication
(10) Pub. No.: US 2012/0280094 A1
(43) Pub. Date: Nov. 8, 2012

(54) DOOR ARTICLE HANGER

(76) Inventor: Kenneth P. Post, Lincoln, MI (US)

(21) Appl. No.: 13/461,938

(22) Filed: May 2, 2012

Related U.S. Application Data
(60) Provisional application No. 61/481,485, filed on May 2, 2011.

(51) Int. Cl. F16M 13/02; B23P 17/00; A44B 18/00

(52) U.S. Cl. 248/205.2; 29/428

(57) ABSTRACT

A door article hanger includes a thin flexible plastic strip terminating opposed first and second ends. Mating hook and loop pads are affixed to the first end of the strip and to the top edge of a door for fixing the strip on the door with the strip bending and extending along one vertical surface of the door. A secondary attachment member is securable to the second end of the strip and mountable about an article or receiving a portion of the article for attaching the article to the second end of the strip to support the article along one vertical surface of the door. The secondary attachment member may be in the form of a hook and loop strap or an elongated tail unitarily formed as part of the strip with mating opposed hook and loop pads which enable the tail to be formed in a loop.

### CROSS REFERENCE TO CO-PENDING APPLICATION

The present application claims priority benefit to the May 3, 2011 filing date of provisional patent application Ser. No. 61/481845 for A PLASTIC OR OTHER FLEXIBLE MATERIAL MULTI-STRAPPED DEVICE IN SYSTEM FOR HANGING OBJECTS ON DOORS, filed in the name of Kenneth P. Post, the contents of which are incorporated herein in its entirety.

### BACKGROUND

The present invention relates, in general, to hanger devices for hanging articles or objects on a door.

A number of different types of hanging devices which are attachable to a house or building interior or exterior door are used to mount articles or objects on the door.

Such hanging devices include a rigid bent metal hanger having a generally U-shaped upper end which is mountable over the top edge of a door between the top edge of the door and the inner edge of the top portion of the door frame. A rigid flat strip extends from the other end of the hanger which is typically formed in an upturned hook to enable a clothes hanger, or articles themselves to be temporarily hung on one side of the door.

However, the use of metal hanger can cause damage to the door and/or the typically painted surface of the door and is subject to rust, particularly if used on an exterior door surface.

Suction cups have also been employed to mount articles or objects on doors. However, suction cups require moisture for attachment which can lead to deterioration of the painted surface of the door or of the door itself. Further, suction cups are typically provided with a hook and therefore still require an elongated strap, string or fishing line to attach an article or object to the suction cup.

Magnetic holders have also been devised; but these are suitable for use only with metal doors. Further, as door hangers are subject to frequent although slight movement during use as the door is opened and closed, any sliding action of the magnets over the door surface causes deterioration of the painted surface of the door.

It would be desirable to provide a door article hanger which addresses these problems; while still providing an easy to use, adjustable length door hanger suitable for use in mounting diverse articles or objects to one or both sides of the door.

### SUMMARY

A door article hanger includes a flexible strip having first and second ends, a two pad hook and loop fastener including a first hook pad and a second loop pad, one of the first and second pads configured for adhesive fixing on a top edge of a door, the other of the first and second pads affixed to the first end of the strip for releasibly affixing the first end of the strip to the one of the first and second pads fixedly mounted on the top edge of the door, and an aperture in second end of the strip capable of receiving an article attachment member.

The door article hanger includes the strip which is formed of a thin flexible plastic material.

The door article hanger includes the strip is formed of a clear, transparent plastic material.

The door article hanger includes the article attachment member with a secondary attachment member mountable to the aperture in the second end of the strip, the secondary attachment member configured for engagement with an article to attach the article to the second end of the strip.

The door article hanger includes the secondary attachment member with a flexible strip having a first hook surface and an opposed loop surface;

an aperture formed in the secondary attachment member for slidably receiving one end of the secondary attachment member therethrough to form a secondary attachment member in a loop with at least one of the ends of the secondary attachment member releasibly adhered to the secondary attachment member.

The door article hanger that includes the article attachment member with an elongated tail unitarily formed and extending from the aperture at the second end of the strip, a hook pad fixed to one surface of the tail, a loop pad affixed to an opposite surface of the tail, and the end of the tail is insertable through the aperture in the second end of the strip into a loop shape wherein the hook and loop pads engage each other.

A method of attaching an article to a door includes releasibly attaching a first end of a thin flexible strip to a top edge of a door, draping an intermediate portion of the strip terminating in a second end downward from the top edge of a door along one vertical surface of the door, and using an article attachment member engaged with the second end of the strip to releasibly attach an article to the second end of the strip to suspend the article along the one vertical surface of the door.

The method of releasibly attaching comprises: attaching a first pad formed of one of hook and loop material to one surface of the first end of the strip; and attaching a second pad of an opposite hook and loop material to the top edge of the door; and fixedly engaging the first pad on the first end of the strip with the second pad mounted on the first end of the door to fixedly mount the strip on the door.

The method of forming an aperture in the second end of the strip for releasibly receiving an article attachment member on the strip.

The step of forming the article attachment member as a unitary portion of the strip extending from aperture in the strip, and inserting an end of the tail through the aperture in the strip and releasibly fixing the portion of the tail inserted through the aperture in the strip to another portion of the tail to form the tail in a loop.

### BRIEF DESCRIPTION OF THE DRAWING

The various features, advantages and other uses of the present invention will become more apparent by referring to the following detailed description and drawing in which:

FIG. 1 is an exploded perspective view of one aspect of a door article hanger;

FIG. 2 is a perspective of a secondary attachment member usable with the door article hanger shown in FIG. 1;

FIG. 3 is a perspective view showing the door article hanger and the secondary attachment member depicted in FIGS. 1 and 2 in a use position mounting a decorative article to one surface of a door;

FIG. 4 is a partial, enlarged rear perspective view showing the use of the secondary attachment member in mounting the decorative article shown in FIG. 3 to the door article hanger;

FIG. 5 is a perspective view of another aspect of a door article hanger;

FIG. 6 is a perspective view of yet another aspect of a door article hanger; and

FIG. 7 is a pictorial representation of another aspect of a door article hanger used to mount diverse articles on one surface of a door.

### DETAILED DESCRIPTION

For purposes of this description, the use of the term “door” is meant to encompass both interior and exterior building or house doors, formed of any material, such as wood, composite, metal, etc. The term “door” also encompasses any typical door construction, such as a single panel door, a bi-fold door, a sliding door, a Dutch door, etc.

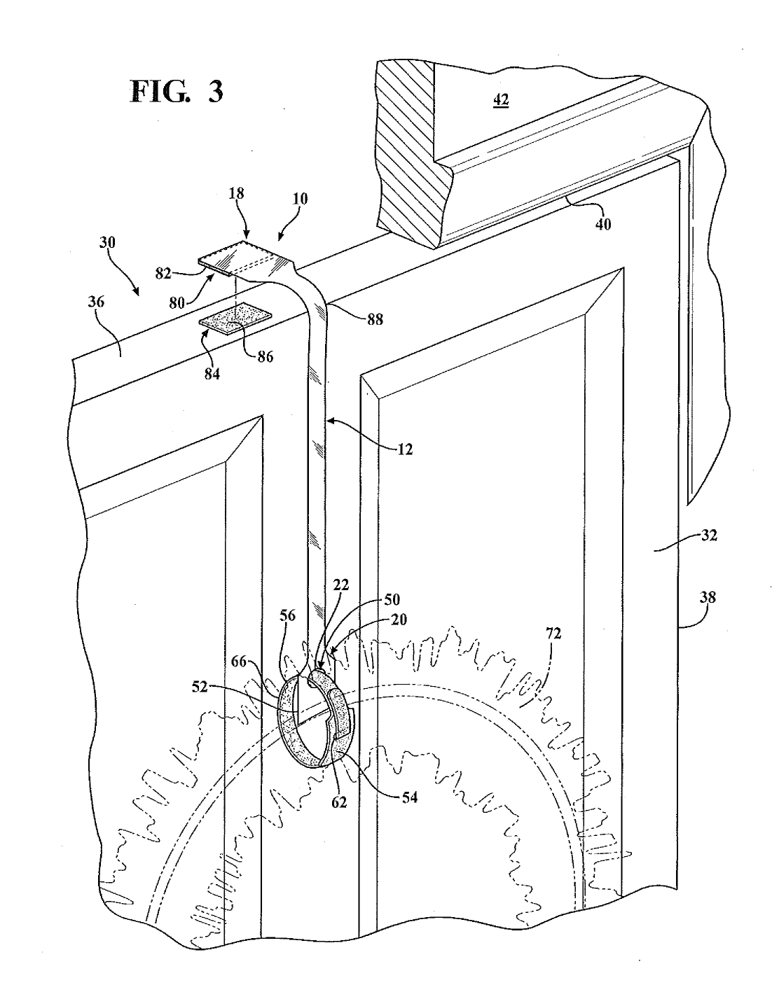

One example of a door 30 is shown in FIG. 3. The door 30 typically has a first major exterior surface 32, and an opposed second major surface 34. The first and second surfaces 32 and 34 are joined together along exterior edges by a top edge 36, side edges 38, only one which is shown, and a bottom edge, also not shown in FIG. 3.

As partially shown in FIG. 3, the top edge 36 of the door 30 is spaced a slight distance below an inner surface 40 of a surrounding door frame 42.

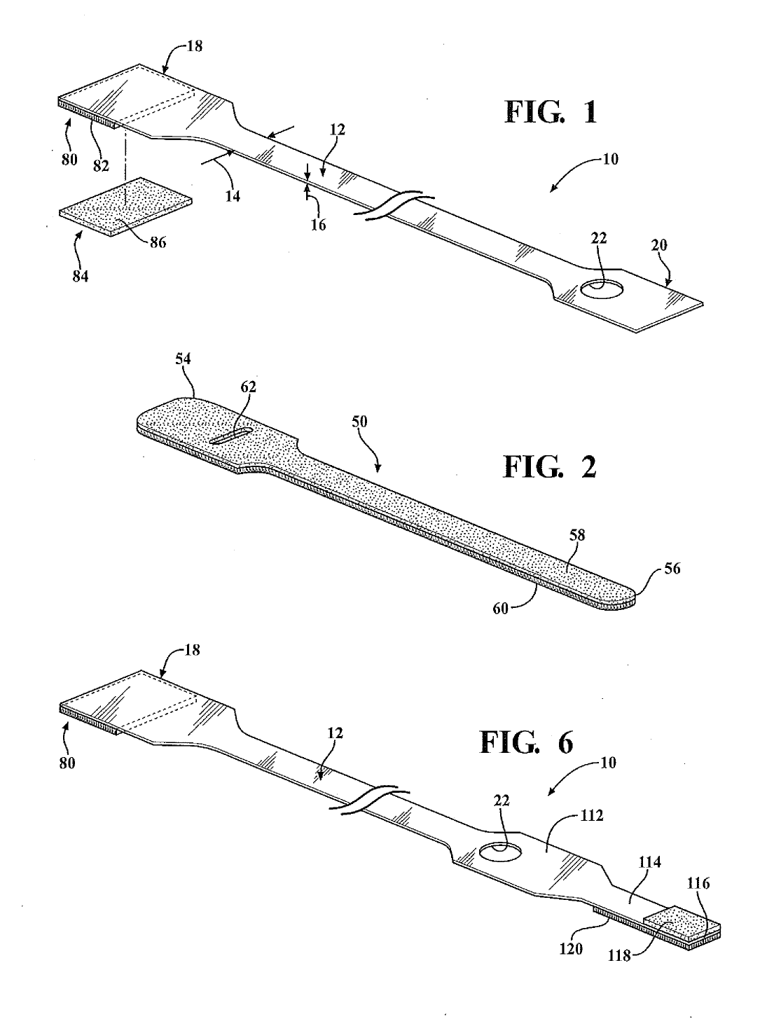

Referring now to the drawing, and to FIGS. 1-4 in particular, there is depicted a door article hanger 10. In one aspect, the door article hanger 10 includes an elongated, thin, flexible member or strip 12 having a narrow width 14, a thin or small thickness 16, and a predetermined length, such as 12 inches, 15 inches, etc., by example only, between a first end 18 and an opposed pad-like shaped second end 20.

The strip 12 forms a hanger based structure which supports the shear weight of the object or articles being hung by the hanger 10 on a door.

The strip 12 can be made of a variety of thin, flexible, but strong materials, preferably one of a number of different types of plastic including, but not limited to, polycarbonate, APET, HDPE, HMPE, PET, PLA, PP, PVC, PS, EVOH, PETE, PETG, PAN and LDPE thermoformed plastics.

The materials used to form the strip 12 can, in one aspect, be a clear transparent material. This makes the strip 12 substantially invisible when mounted on the door 30, as seen in FIG. 3. Alternately, the strip 12 could have color additives to provide the strip 12 in various colors which are identical to common door colors or contrasting colors to coordinate with the color of the article or object being hung on the door 30 by the door article hanger 10.

Although the door hanger strip 12 may have a constant width 14 and a constant thickness 16 between the first and second ends 18 and 20, in one aspect, the first end 18 of the door article hanger 10 has an enlarged width greater than the width 14 of the strip 12. By example only, the width of the first end 18 can be about ⅞^{th} of an inch across. The length of the first end 18 may also be from about ⅞^{th} of an inch up to about 2.0 inches to form a generally pad-like surface at the first end 18 of the door article hanger 10.

As described above, the strip 12 may have any suitable length. A 12 inch length between the inner ends of the first and second ends 18 and 20 will be understood to be by way of example only as such a length will enable an object or article, such as a decorative wreath, to be mounted on the door surface 32 at a standard, easily visible height. Shorter or longer lengths, such as a 15 inch length, are also possible.

The width 14 of the elongated strip 12 of the door article hanger 10 can be any suitable width. The width 14 of the strip 12 can range from between approximately ⅛ inch up to approximately 0.50 inch, for example only. A ¼ inch width 14 can also be employed.

The thickness 16 of the strip 12 can also vary between approximately 0.0005 inches up to approximately 0.50 inch. One example of a strip 12 thickness 16 is between about 0.005 inches and about 0.25 inch. In one aspect, the strap 12 can have a thickness of about 0.15 inches to about 0.20 inches.

The second end 20 of the door article hanger 10 can be of the same width as the width 14 of the strip portion 12 of the door article hanger 10. By way of example only, the second end 20 of the door article hanger 10 is illustrated in FIG. 1 as having a slightly enlarged shape, having a width slightly bigger than the width 14 of the strip 12 to form an enlarged pad-like surface at the second end 20 of the hanger 10.

The first end 18 of the strip 12 has a thin hook or loop pad 80 affixed to one side. The pad 80 can carry a self-adhesive layer or simply be attached to the first end 18 of the strip 12 by a separate application of adhesive. By way of example only, the pad 80 is depicted in FIG. 3 as having a plurality of hook-like projections 82.

A mounting pad 84 which carries the opposite hook or loop construction, with a loop construction 86 depicted in FIG. 3 for mating engagement with the hook projections 82 on the pad 80, is mounted again, by a self-adhesive layer carried on the pad 84 or by a separate application of adhesive to the pad 80, to the top edge 36 of the door 30. The mounting pad 84 provides a base for one end of the hanger strip 12.

The self-adhesive or separate adhesive on the pads 80 and 84 can be a PSA tape or other types of simply quick application adhesives.

In use, the mounting pad 84 is attached by an adhesive layer to the top edge 36 of the door 30, at any location across the width of the door, although a generally central location would be more typical. The pad 80 on the first end 18 of the strip 12 is then adhered to the mounting pad 84. Due to the thinness of the mounting pad 84, the attachment pad 80 and the first end 18 of the strip 12, the first end 18 of the strip 12 and the attached hook and loop pads 80 and 84 fit easily within the small open space between the top edge 36 of the door and the adjacent inner edge 40 of the door frame 42 without contact or interference which would hinder movement of the door 30 relative to the door frame 42.

The strip 12 is then draped smoothly over one edge of the top edge 36 of the door 30 until the strip 12 assumes a substantially vertical position as shown in FIG. 3. In this position, a portion 88 of the strip 12 between the first end 18 and the adjacent beginning of the middle portion of the strip 12 assumes a smoothly curved shape extending slightly away from the door 30. This smooth shape then transitions into a generally linear shape for the intermediate portion of the strip 12 along the remaining length of the strip 12 to the second end 20.

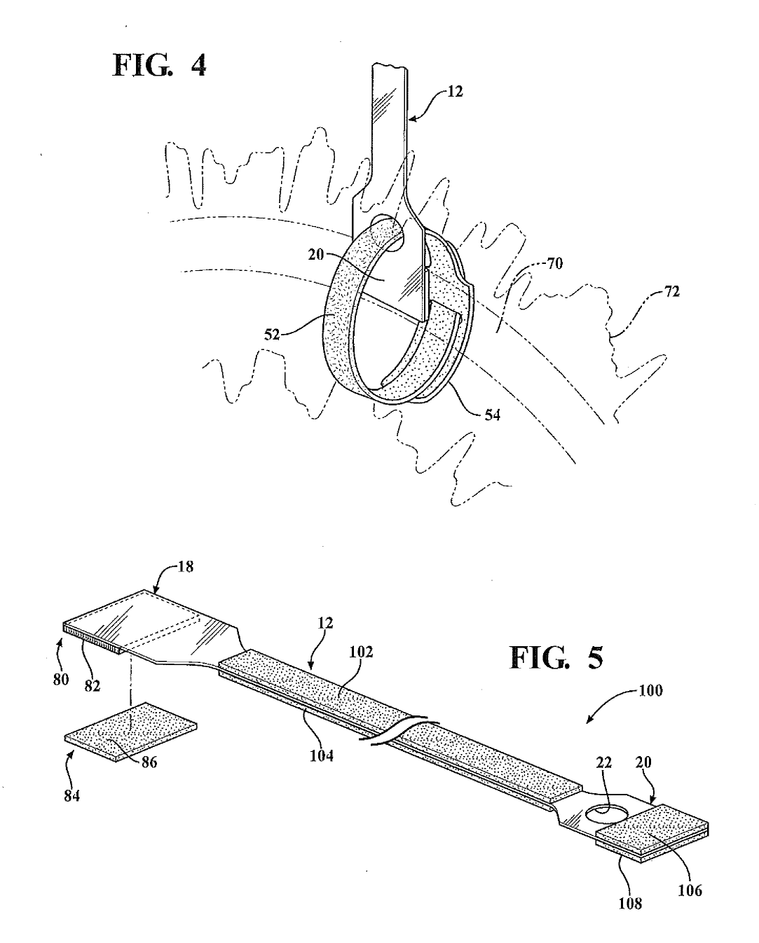

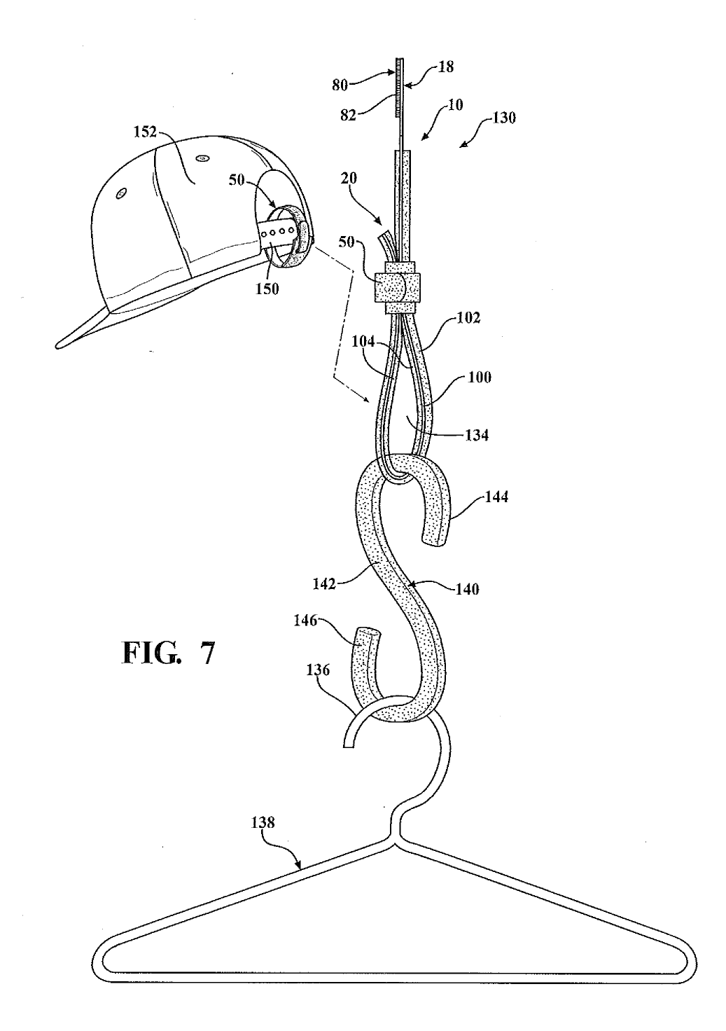

The attachment member, such as the secondary attachment member 50, is then secured to the strip 12 through the aperture 22 in the second 20 of the strip 12 and wrapped around and adhered to itself in a loop and encircling a support member 70 of the article 72 being hung, See FIG. 4 to attach the article 72 to the door 30.

An aperture 22 which may have any suitable shape, such as a circular cross section, oval, slot, etc., is formed in the second end 20. The aperture 22 is capable of receiving an article attachment member. In one aspect, the article attachment member can be a hook or other attachment member carried on an object or article which is to be hung on the door 30.

Due to the selection of the suitable, flexible, strong plastic material described above, a width 14 and a thickness 16 within the ranges described above, the door article hanger 10 exhibits a combination of flexibility for easy mounting on a door surface 32, scratch resistance, smooth surfaces and edges which prevent damage to the door surface 32, and is capable of supporting a large number of fairly heavy objects or articles along either door surface 32 or 34.

In another aspect, the article attachment member can be a separate secondary attachment member. The aperture 22 enables the secondary attachment member to be coupled to the strip 12 and secured about a support member on a decorative article or simply formed in the loop to receive one end of a clothes hanger, as described hereafter, to attach the article or object to the door article hanger 10.

The secondary attachment member can take the form of any suitable clip, hook, S-hook, which is formed of metal, plastic or plastic coated metal.

One example of a secondary attachment member 50 is shown in FIG. 2. The secondary attachment member 50 is in the form of a strap 52 having opposed first and second ends 54 and 56. By way of example, the strap 52 is formed with a first loop or pile surface 58 and an opposed hook surface 60.

The first end 54 of the secondary attachment member 50 maybe formed as an enlarged pad, having a slightly greater width than the width of the remainder of the strap 52. An aperture, which is formed, by way of example only, as a slot 62, is formed in the first end 54 and is sized to removably and slidably receive the second end 56 of the strap 56 therethrough.

The hook and loop construction of the opposite sides 58 and 60 of the strap 52 enables the second end 56 of the strap 56, after being inserted through the slot 62 in the first end 54 of the secondary attachment member 50, to adhere to itself and form a circular shaped loop 66, as shown in FIG. 3, about a support member 70, such as the reeds or rod forming a break support for a decorative wreath. The generally circular joined arrangement of the ends 54 and 56 of the secondary attachment member 50, by forming a loop which is secured to the second end 22 of the door article hanger strip 12, can also be used for removable insertion of another hook, such as one end of a clothes hanger, etc.

Another aspect of a door article hanger 100 is shown in FIG. 5. The hanger 100 is similar to the hanger 10 as it includes the intermediate strip 12 having the first end 18 and the opposed second end 20 with the aperture 22, substantially the same as the door article hanger 10 described above and shown in FIGS. 1 and 3.

In this aspect, substantially the entire length of at least one or both sides of the intermediate portion of the strip 12 of the hanger 100 is covered by loop fastener strips 102 and 104. The strips 102 and 104 may extend continuously between the first and second ends 18 and 20 or they may be provided in discontinuous segments with small spaces between each segment.

As also shown in FIG. 5, at least one, with two being shown by example only, optional loop pads 106 and 108 are adhesively secured to the edge of opposed sides of the second end 20 of the strip 12.

The loop strips 102 and 104 as well as the loop pads 106 and 108 provide attachment surfaces along the length of the strip 12 and on the second end 20 of the strip 12 for easy attachment of secondary attachment members, such as secondary attachment member 50 having outward extending hooks, to be attached to any portion of the length of the strip 12, as described hereafter, for example, and shown in FIG. 8.

The loop strips 102 and 104 and the loop pads 106 and 108 may also be provided in a number of different colors to color coordinate the hanger 100 to the color of a door as well as to provide seasonal colors to match, coordinate or contrast with the article being hung by the hanger 100 on a door.

Another aspect of door article hanger 110 is shown in FIG. 6. The hanger 110 is substantially identical to the hanger 10 with an elongated middle strip portion 12 with an enlarged first end 18. In this aspect, however, an enlarged pad 112 is formed at one end of the middle strip portion 12 surrounding the aperture 22. An elongated tail 114 terminating in a second end 116 of the hanger 110 extends linearly from the enlarged pad 112. The tail 114 may have the same width as the width of the middle strip portion 12 of the hanger 110 so as to enable the second end 116 to be slidably inserted through the aperture 22 of the enlarged pad 112.

A loop pad 118 is adhesively affixed to one surface of the tail 114, generally adjacent to the second end 116. A hook pad 120 is adhesively adhered to the other surface of the tail 114 and extends along a substantial portion of the length of the tail 114 from the end 116 to the beginning of the enlarged pad 112.

This unitary one piece construction combines the elongated hanger 10 of FIG. 1 with an integral secondary attachment member in the form of the tail 114 with an opposed loop pad 118 and hook pad 120.

In use, the second end 116 may be slidably inserted through the aperture 22 and looped back on itself in the direction of arrow 122 in FIG. 6 until the loop pad 118 can be brought into secure engage with a portion of the hook pad 120. This forms the tail 114 in the desired loop for encircling a support member of a decorative article similar to that shown in FIG. 4, or simply for receiving one end of an article or object, such as a clothes hanger.

Yet another of a door article hanger 130 is shown in FIG. 8. In this aspect, by example only, the main door hanger portion is formed identical to the door hanger 100 shown in FIG. 5 with opposed loop pads 102 and 104 extending along the length of the middle strip portion 12 of the hanger 130.

In this aspect, the second end 20 of the hanger 130 is looped back on itself until the opposed ends of the loop pad 104 are brought into substantial alignment. One secondary attachment member 50 may then be wound tightly about the joined portions of the strip 12 and the second end 20 to form the strip portion 12 of the hanger 130 in a general loop shape. The loop 134 can directly receive a hook end of an article or object, such as the hook end 136 of a conventional clothes hanger 138.

Alternately, a secondary attachment member in the form of an S-shaped hook 140 is provided. The secondary attachment member or hook 140 includes an intermediate or middle strip portion 142 and opposed ends 144 and 146 which are bent out of the plane of the intermediate strip portion 142 into oppositely facing U-shaped hooks. The first hook end 144 of the secondary attachment strip 140 may be inserted through the loop 136 in the hanger 130. The second hook end 146 of the secondary attachment member 140 extends freely downward from the strip 100 and is suitable for directly receiving articles or the mounting ends of articles, such as the hook end 136 of a clothes hanger 138.

Another use of the hanger 130 which has a loop pad 102 or 104 formed on one or both opposed surfaces is also illustrated in FIG. 8. In this aspect, the secondary attachment member 50, described above, is wound in a self-adhering loop about a tag or the adjustment straps 150 of a baseball cap 152. The exposed hook surface on the secondary attachment member 50 can then be releasibly adhered at any position along the length of the exposed loop pads 102 of 104 on the hanger 100 to also hang caps along one surface 32 of the door 30.

It will be understood that in the various aspects of the door article hanger described above, the hook and loop pads or members attached to the thin strip portions of the various hangers can be reversed from that illustrated by way of example only in the drawings and the above description. That is, the hook pad 80 on the first end 18 of the hanger 100 can be replaced with a loop pad. The mounting pad 84 which is attached to the top edge 36 of the door 30 may also be provided in the form of a hook pad to mate with a loop pad on the first end 18 of the strip 12.

The above described door article hangers solve multiple problems with regard to function and aesthetics for hanging articles or objects on doors. The inventive door article hanger eliminates door damage when hanging an object on a door with conventional door hangers, requires no tool or nails or other fasteners, reduces time and resource issues due to existing traditional and old-fashioned hanging methods, such as the use of nails, or fasteners and the elimination of unsightly or unattractive aspects of current door hanging methods such as exposed metal hanger pieces.

The present door article hanger is a multi-functional device that can be used to hang seasonal wreaths and other holiday items on a door, plus other household applications, such as hanging hats, shirts, pants or clothes on doors. In addition to these applications, the door article hanger can also be used for hanging work materials in the garage, such as towels and rags. Unlike most other door hanging devices, the present door article hanger can be used in both indoor and outdoor applications. The door article hanger can be customized to length to fit any application mounting requirements. Prior art door hanging devices typically come in one size and are not easily customized.

Unlike metal door hangers which can rust or otherwise scrap and damage door surfaces, the present door article hanger is soft and flexible to prevent damage to the door surface as well as being able to be provided in a clear transparent form for substantial invisibility on the door, or color coated to blend in with any door color.

What is claimed is:

1. A door article hanger comprising:
a flexible strip having first and second ends;
a two pad hook and loop fastener including a first hook pad and a second loop pad, one of the first and second pads configured for adhesive fixing on a top edge of a door, the other of the first and second pads affixed to the first end of the strip for releasibly affixing the first end of the strip to the one of the first and second pads fixedly mounted on the top edge of the door; and
an aperture in second end of the strip capable of receiving an article attachment member.

2. The door article hanger of claim 1 wherein:
the strip is formed of a thin flexible plastic material.

3. The door article hanger of claim 1 wherein:
the strip is formed of a clear, transparent plastic material.

4. The door article hanger of claim 1 wherein the article attachment member comprises:
a secondary attachment member mountable to the aperture in the second end of the strip, the secondary attachment member configured for engagement with an article to attach the article to the second end of the strip.

5. The door article hanger of claim 4 wherein the secondary attachment member comprises:
a flexible strip having a first hook surface and an opposed loop surface;
an aperture formed in the secondary attachment member for slidably receiving one end of the secondary attachment member therethrough to form a secondary attachment member in a loop with at least one of the ends of the secondary attachment member releasibly adhered to the secondary attachment member.

6. The door article hanger of claim 1 wherein:
the article attachment member comprises an elongated tail unitarily formed and extending from the aperture at the second end of the strip;
a hook pad fixed to one surface of the tail;
a loop pad affixed to an opposite surface of the tail; and wherein
the end of the tail is insertable through the aperture in the second end of the strip into a loop shape wherein the hook and loop pads engage each other.

7. The door article hanger of claim 1 wherein:
the strip has a thickness of between about 0.0005 inches to about 0.25 inches.

8. The door article hanger of claim 7 wherein:
the strip has a thickness of between about 0.005 inches to about 0.25 inches.

9. The door article hanger of claim 7 wherein:
the strip has a thickness of between about 0.15 inches to about 0.20 inches.

10. A method of attaching an article to a door comprising:
releasibly attaching a first end of a thin flexible strip to a top edge of a door;
draping an intermediate portion of the strip terminating in a second end downward from the top edge of a door along one vertical surface of the door; and
using an article attachment member engaged with the second end of the strip to releasibly attach an article to the second end of the strip to suspend the article along the one vertical surface of the door.

11. The method of claim 10 wherein the step of releasibly attaching comprises:
attaching a first pad formed of one of hook and loop material to one surface of the first end of the strip; and
attaching a second pad of an opposite hook and loop material to the top edge of the door; and
fixedly engaging the first pad on the first end of the strip with the second pad mounted on the first end of the door to fixedly mount the strip on the door.

12. The method of claim 10 further comprising:
forming an aperture in the second end of the strip for releasibly receiving an article attachment member on the strip.

13. The method of claim 10 further comprising:
forming the article attachment member as a unitary portion of the strip extending from aperture in the strip; and
inserting an end of the tail through the aperture in the strip and releasibly fixing the portion of the tail inserted through the aperture in the strip to another portion of the tail to form the tail in a loop.
